(19) United States
(12) Patent Application Publication
(10) Pub. No.: US 2019/0034905 A1
(43) Pub. Date: Jan. 31, 2019

(54) RIDE SHARING BENEFIT ADMINISTRATION PLATFORM

(71) Applicant: Claim Ride, LLC, Boca Raton, FL (US)

(72) Inventors: LESLIE SCHLESINGER, Boca Raton, FL (US); GONEN MINUSKIN, Boca Raton, FL (US)

(21) Appl. No.: 16/046,793

(22) Filed: Jul. 26, 2018

Related U.S. Application Data
(60) Provisional application No. 62/537,119, filed on Jul. 26, 2017.

(51) Int. Cl. G06Q 20/24; G06F 17/30; G06Q 40/08

(52) U.S. Cl. CPC G06Q 20/24; G06Q 40/08; G06F 17/30864

(57) ABSTRACT

A ride sharing benefit administration platform is provided. The ride sharing benefit administration platform may be embodied as a method, comprising the steps of: specifying a customer and a monetary value associated with an incident within a CRM module; requesting issuance of credit via a merchant API module; establishing a credit account for the customer with the specified monetary value; sharing credit account data with the customer via a customer application module; enabling an application of the credit account to a ride sharing platform via a ride sharing API module; tracking usage of the credit account via a credit account management module; and closing the credit account upon meeting account deactivation criteria. The ride sharing platform may be further embodied as a system at least one of the following: a CRM module; an Customer Application module; a Merchant API module; a Credit Account Management module; and a Ride Sharing API module.

### RELATED APPLICATION(S)

Under provisions of 35 U.S.C. § 119(e), the Applicants claim the benefit of U.S. provisional application No. 62/537,119, filed Jul. 26, 2017, which is incorporated herein by reference.

APPENDIX A as presented in the U.S. provisional application No. 62/537,119, filed Jul. 26, 2017 is herein incorporated by reference. APPENDIX A disclosed various additional methods and systems associated with the various embodiments detailed in the U.S. provisional application No. 62/537,119, filed Jul. 26, 2017.

It is intended that each of the referenced applications may be applicable to the concepts and embodiments disclosed herein, even if such concepts and embodiments are disclosed in the referenced applications with different limitations and configurations and described using different examples and terminology.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing various embodiments of the present disclosure;

FIG. 3 is a block diagram of a system including a computing device for performing, at least, the method of FIG. 2; and

FIG. 4 illustrates one possible system architecture for the ClaimRide® platform in accordance to the embodiments disclosed herein.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of credit accounts, embodiments of the present disclosure are not limited to use only in this context. For example, and account associated with a financial institution (e.g., debit accounts, gift cards, and the like) may be used without deviating from the spirit and scope of the present disclosure. Additional examples of applicable embodiments include, but are not limited to:
Property & Casualty Insurance
Life & Health Insurance
Roadside Assistance Companies
Warranty Companies
Rental Car Companies
Motor Clubs
Automobile Dealerships
Automobile Manufacturers
Any Industry that offers replacement vehicle services, substitute transportation services or reimbursement for transportation services

### I. PLATFORM OVERVIEW

Consistent with embodiments of the present disclosure, a ride sharing benefit administration platform may be provided. This overview is provided to introduce a selection of concepts in a simplified form that are further described below. This overview is not intended to identify key features or essential features of the claimed subject matter. Nor is this overview intended to be used to limit the claimed subject matter's scope.

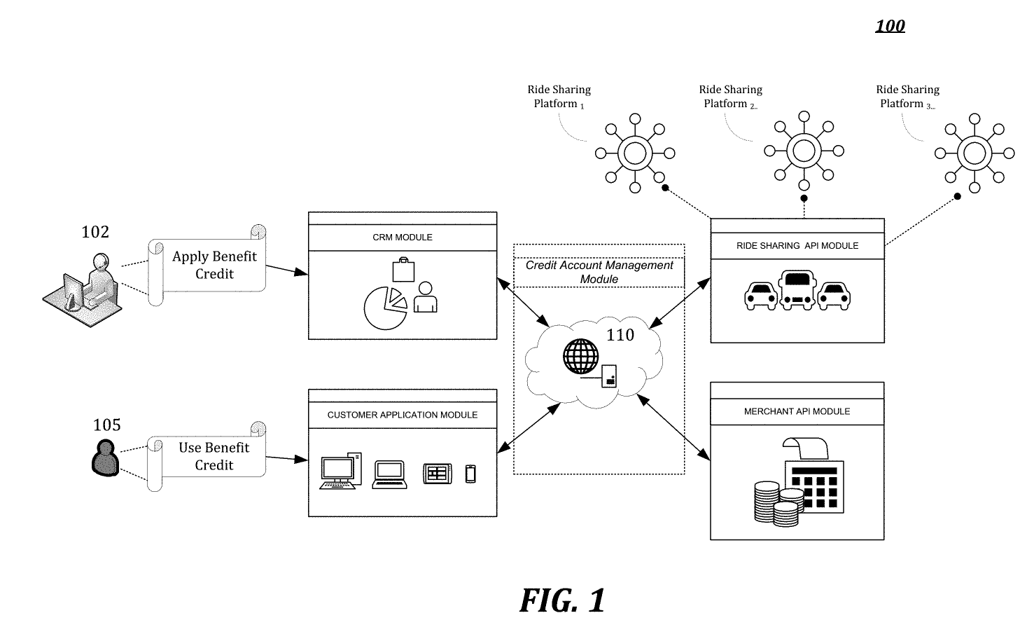

FIG. 1 illustrates just one of many embodiments for providing an operating environment compatible with the systems and methods of the present disclosures. FIG. 1 will be detailed below.

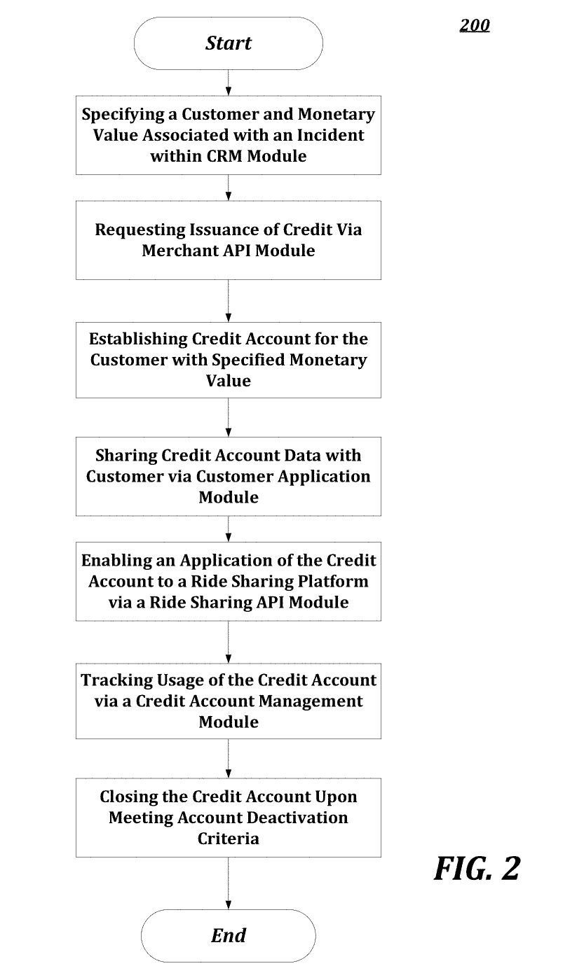

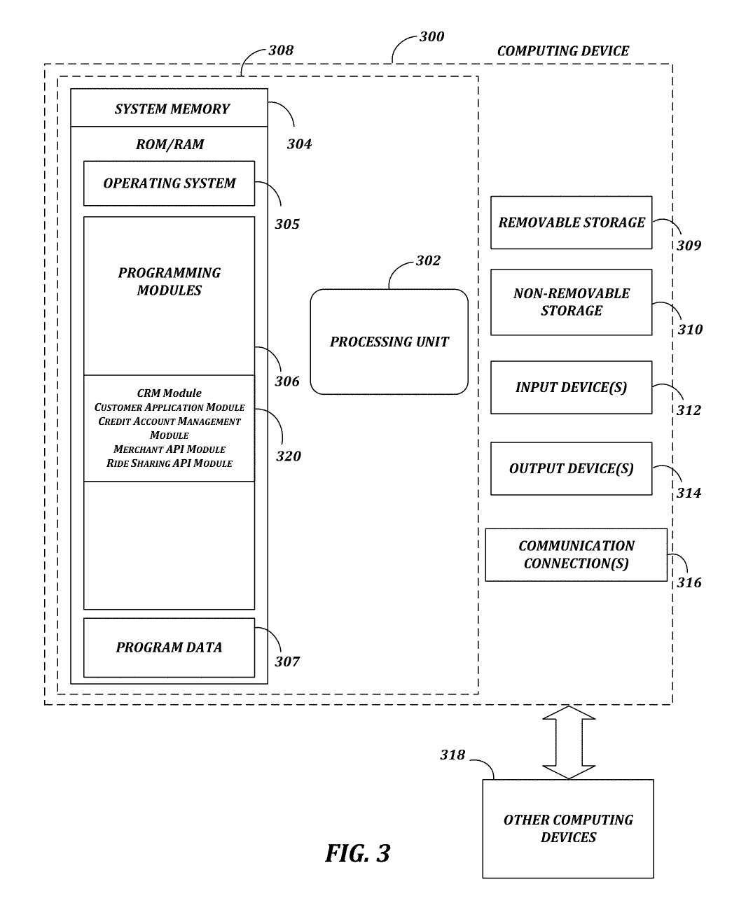

FIG. 2 is a flow chart setting forth the general stages involved in a method 200 consistent with an embodiment of the disclosure for providing platform 100. Method 200 may be implemented using a computing device 300 as described in more detail below with respect to FIG. 3.

It should be understood that, in some embodiments, different operations may be performed by different networked elements in operative communication with computing device 300. For example, server 110 and/or computing device 300 may be employed in the performance of some or all of the stages in method 200. Moreover, server 110 may be configured much like computing device 300 and, in some instances, be one and the same embodiment.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 are illustrated, and may be summarized as follows.

Platform 100 may be configured to perform, but is not limited to, a method comprising the following stages:
establishing a customer record in a database;
associating the customer record with an incident;
determining a monetary value associated with the incident;
issuing a credit corresponding to the determined monetary value;
   wherein issuing the credit based upon the monetary value comprises:
      accessing an API,
      requesting, via the API, an issuance of a credit account
      corresponding to the credit,
         wherein requesting the issuance of a credit account comprises submitting a customer name and customer contact information;
      establishing the credit account;
      issuing, via the API, a confirmation of a credit issuance, and
      enabling, via the API, modifications to the credit account,
      wherein the modifications comprise at least one of the following:
         adding to a credit amount to the credit account,
         removing a credit amount from the credit account, and
         transferring a credit amount to another credit account;
sharing credit account data, wherein sharing the credit account data comprises at least one of the following:
   transmitting a first set of data points associated with the credit account directly to a customer associated with the customer record, wherein transmitting the first set of data points comprises:
      retrieving, via an API, contact information for the customer from the customer record,
      enabling the customer to obtain an application for receiving and displaying the first set of data points, and sharing the first set of data points with the customer,
      wherein the first set of data points are not available to the customer record database;
   transmitting a second set of data points associated with the credit account to the customer record database,
      wherein a portion of the second set of data points correspond to the first set of data points; and
   transmitting credit account data to a Ride Sharing Platform via a Ride Sharing API, wherein transmitting the credit account data to the Ride Sharing Platform further comprises:
      enabling, via the Ride Sharing API, the credit account data to be used for services provided by the Ride Sharing platform,
      wherein the Ride Sharing Platform is configured to transition from the credit account data to previously used transaction upon a closing of the credit account;
tracking a usage of the credit account in the customer record;
   wherein tracking the usage of the credit comprises:
      receiving an update from a Merchant API, and
      displaying the update in the customer record of a CRM module;
      receiving an update from the Ride Sharing API, and
      displaying the update in the customer record of the CRM;
closing the credit account,
   wherein closing the credit account comprises at least one of the following:
      paying an account balance associated with the credit account on behalf of the customer,
      suspending the account from further usage, and disabling the credit account.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

FIG. 1 illustrates one possible operating environment through which a platform consistent with embodiments of the present disclosure may be provided. By way of non-limiting example, a ride sharing benefit administration platform 100 may be hosted on a centralized server 110, such as, for example, a cloud computing service. A users 102 and 105 may access platform 100 through a software application. The software application may be embodied as, for example, but not be limited to, a website, a web application, a desktop application, and a mobile application compatible with a computing device 300. One possible embodiment of the software application may be provided by the CLAIM RIDE® suite of products and services provided by CLAIM RIDE LLC.

### III. PLATFORM OPERATION

The claims break down the invention into computing modules, used for illustrative, non-limiting purposes.

I. A CRM module;

II. An Customer Application module;

III. A Merchant API module;

IV. A Credit Account Management module; and

V. A Ride Sharing API module.

Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each stage in the claim language can be considered independently without the context of the other stages. Each stage may contain language defined in other portions of this specifications. Each stage disclosed for one module may be mixed with the operational stages of another module. Each stage can be claimed on its own and/or interchangeably with other stages of other modules. The following claims will detail the operation of each module, and inter-operation between modules.

Although the stages disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

Finally, the claims are not structured in the same way non-provisional claims are structured. For example, indentations indicate optional/dependent elements of a parent element.

I. A CRM Module

wherein the CRM Module is configured for:

retrieving a customer record in a database;
wherein the customer record is stored within a CRM software,
   wherein the CRM software is configured to manage insurance claims,
      wherein the CRM software comprises, for each customer records, but is not limited to, at least one of the following:
         carrier information, policy information, beneficiary information, current benefit, benefit balance, benefit duration, and credit account activity,
   wherein the CRM software is configured to authorize a credit account for the customer,
associating the customer record with a incident;
   wherein the incident comprises a claim for compensating a customer associated with the record;
specifying a monetary value associated with the incident;
   wherein the monetary value corresponds to a calculation of a compensation amount for the claim,
      wherein the monetary value is associated with a daily budget provided to the customer associated with the record, and
      wherein the daily budget is specified to be allocated for a number of days;
requesting an issuance of a credit account associated with the customer record,
   wherein the issuance request is performed via the Merchant API Module,
      wherein requesting the issuance of the credit comprises submitting at least one of the following:
         a beneficiary name, and
         contact information associated with the beneficiary;

confirming the issuance of the credit account associated with the customer record,
wherein the confirmation of the issuance is performed the Merchant API Module;

causing a communication of credit account data to the customer,
wherein causing the communication of the credit account data to the customer comprises at least one of the following:
   providing customer record data to the Merchant API Module;
      wherein the customer record data comprising customer contact information, the customer contact information being used to communicate account data, via the Merchant API Module, to the customer,

displaying a credit account associated with the customer record,
wherein displaying the credit account associated with the customer record further comprises tracking a usage of the credit account via the Credit Account Management Module,
wherein updated values associated with the credit account are retrieved from the Merchant API Module;

tracking a usage of the credit account associated with customer record,
wherein tracking the usage of the credit account data comprises communicating data with at least one of, or a combination of, the following:
   the Merchant API Module,
   the Ride Sharing API Module, and
   the Credit Account Management Module,

enabling modifications the credit account associated with the customer record,
wherein the modifications comprise at least one of the following:
   adding a monetary value to the credit account,
   removing a monetary value from the credit account, and
   transferring a monetary value to another credit account,
wherein the modifications are enabled via the Merchant API Module;

closing the credit account,
wherein closing comprising paying the balance associated with the credit account on behalf of the customer,
wherein closing comprising suspending the account from further usage, and
wherein closing the credit account is enabled via the Merchant API Module;

II. An Customer Application Module

wherein the Customer application is operable with at least one of the following:
The CRM Module;
The Merchant API Module; and
The Ride Sharing API Module.

Customer Application Module Operation

providing an application to the customer associated with the customer record,

wherein providing the application comprises enabling the customer to download an application,
wherein enabling the customer to download the application comprises communicating a link to the customer,
   wherein communicating the link with the customer comprises communicating the link via at least one of the following:
      SMS, MMS, and EMAIL,
   wherein communicating a link comprises communicating a unique ID in addition to the link,
      wherein the unique ID is configured to associate the application with the customer record in the CRM Module;

wherein the application is at least one of the following;
an application configured to operate on a mobile computing device, and
a web-based application;

wherein the application is an extension to the CRM Module,
wherein the application is operable via communication with the CRM Module,
   wherein the CRM Module is configured to remotely operate at least one feature and at least one function of the application,

wherein the application is configured to communicate with the Merchant API Module,
wherein the Merchant API Module is configured to communicate credit account data to the application,
   wherein at least a portion of the credit account data is not accessible to the CRM Module,

wherein the application is configured to display credit account data to the customer,
wherein the credit account data is received from at least one of, or a combination of, the following:
   the Merchant API Module, and
   the CRM Module;
wherein the credit account data comprises at least one of the following:
   a credit account number,
   a credit account expiration date,
   a credit account provider, and
   an image associated with any of the aforementioned elements;

wherein the application is configured to display a credit account status to the customer,
wherein the credit account data is received from at least one of, or a combination of, the following:
   the Merchant API Module, and
   the CRM Module;
wherein the credit account status comprises at least one of the following:
   an insurance carrier associated with the credit account,
   a claim number associated with the credit account,
   an authorized benefit corresponding to a monetary value,
   a benefit balance corresponding to a balance of the credit account;

wherein the application is configured to enable an operation of a Ride Sharing API Module,
wherein the operation of the Ride Sharing API Module comprises loading a Ride Sharing Application,
   the Ride Sharing Application comprising, but not limited to, any one of the following:
      Uber,
      Lyft, and
      Gett;
wherein the operation of the Ride Sharing API Module comprises communicating credit account data to the Ride Sharing API Module,
   wherein communicating the credit account data comprises causing the Merchant API Module to communicate credit account data to a Ride Sharing API Module,
   wherein communicating the credit account data comprises:
      replacing an existing credit account associated with the customer's record with a credit account issued by the Merchant API Module,
         wherein replacing the existing credit account with the issued credit account comprises:
         enabling the Ride Sharing API Module to charge the issued credit account for usage, and
         replacing the issued credit account with the existing credit account once a monetary value associated with the issued credit account has been depleted.

III. A Merchant API Module

wherein the Merchant API Module is configured for:

Issuing a Credit

issuing a credit corresponding to the specified monetary value;
wherein issuing the credit corresponding to the specified monetary value comprises issuing a credit in response to a request from a CRM Module;
wherein operating the Merchant API Module comprises operating the Merchant API Module in accordance to instructions received from at least one of the following:
   the CRM Module, and
   the Credit Account Management Module,

accessing a financial institution system via the Merchant API;

requesting, via the Merchant API, an issuance of a credit account for the customer,
wherein requesting the issuance of the credit comprises providing at least one of the following along with the request:
   a customer name, and
   customer contact information;

establishing the credit account;
the credit account comprising a credit value corresponding to the monetary value,

providing a confirmation of the credit account issuance,
wherein providing the confirmation of the credit account issuance comprises providing the confirmation to at lease on of the following:
   the CRM Module, and
   the Credit Account Management Module,

Sharing Credit Account Data

### Embodiment 1—Generic

sharing the credit account data,
   wherein the credit account data comprises at least one of the following:
      a credit account number,
      a credit account expiration date,
      a credit account provider, and
      an image associated with any of the aforementioned elements;

### Embodiment 2—Credit Account Management Module

transmitting the credit account data to a Credit Account Management Module,
enabling, via the Credit Account Management Module, the credit account data to be tracked and modified,
   wherein the Merchant API is configured to modify the credit account data in response to requests for modifications from the Credit Account Management Module, and
   wherein the Merchant API is configured to update credit account data to the Credit Account Management Module;

### Embodiment 3—CRM Module

transmitting the credit account data to a CRM Module,
enabling, via the CRM Module, the credit account data to be tracked and modified,
   wherein the Merchant API is configured to modify the credit account data in response to requests for modifications from the CRM Module, and
   wherein the Merchant API is configured to update credit account data to the CRM Module;

### Embodiment 4—Application Associated with the CRM Module

transmitting the credit account data to an application in operative communication with the Customer Application Module,
enabling, via the application, the credit account data to be tracked and modified,
   wherein the Merchant API is configured to modify the credit account data in response to requests for modifications from the application, and
   wherein the Merchant API is configured to update credit account data to the application;

### Embodiment 5—Ride Sharing API Module

transmitting the credit account data to a Ride Sharing Platform via a Ride Sharing API Module,
enabling, via the Ride Sharing API Module, the credit account data to be used for services provided by the Ride Sharing Platform,
   wherein the Ride Sharing Platform is configured to transition from the credit account data to previously used transaction upon a closing of the credit account;

Modifying a Credit Account

enabling a modification to the credit account,
wherein the modification comprises at least one of the following:
   adding a monetary value to the credit account,
   removing a monetary value from the credit account, and
   transferring a monetary value to another credit account,
      wherein modifying the credit account comprises modifying the credit account in response to receiving a modification request from at least one of the following:
         the Credit Account Management Module, and
         the CRM Module;

Editing a Credit Account

enabling an editing of the credit account,
wherein editing the credit account comprises at least one of the following:
   modifying parameters associated with the credit account,
      wherein modifying the parameters associated with the credit account comprises, but is not limited to, at least one of the following:
         receiving a daily allocation of credit,
         receiving a duration for the credit allocation, and
         receiving a modification to any one of the aforementioned elements,
wherein editing the credit account comprises receiving a request to edit the credit account from at least one of the following:
   the CRM Module,
   the Credit Account Management Module;

Closing a Credit Account

closing the credit account,
wherein closing comprising paying the balance associated with the credit account on behalf of the customer,
wherein closing comprising suspending the account from further usage,
wherein closing the credit account comprises receiving a request to close the credit account from at least one of the following:
   the CRM Module,
   the Credit Account Management Module;

### IV. A CREDIT ACCOUNT MANAGEMENT MODULE

wherein the Credit Account Management Module is configured for:

Issuing a Credit

requesting an issuance of a credit account associated with the customer record,
wherein the customer record is retrieved from the CRM Module,
wherein the issuance request is performed via the Merchant API Module,
   wherein requesting the issuance of the credit comprises providing, to the Merchant API Module, at least one of the following:
      a beneficiary name, and
      contact information associated with the beneficiary;

confirming the issuance of the credit account associated with the customer record,
wherein the confirmation of the issuance is performed the Merchant API Module;

Controlling the Credit Account Data

controlling the distribution and usage of the credit account data;
wherein controlling the distribution and usage of the credit account data associated with the customer comprises at least one of the following:

### Embodiment 1—CRM Module Communication

enabling a transmission of the credit account data directly to a customer associated with the customer record, wherein transmitting the credit account data comprises:
   retrieving contact information for the customer from the customer record,
      wherein retrieving the contact information employs the CRM Module, and
   sharing the credit account data with the customer,
      wherein sharing the credit account data employs the Merchant API module,
      wherein a portion of the credit account data shared with the customer is not available to the CRM Module,
         wherein the portion of the credit account data not available to the CRM module comprises, but is not limited to, a credit card number;
enabling a transmission of a limited portion of the credit account data to the CRM module,
   wherein the limited portion of the credit account data excludes the credit card number,
   wherein the limited portion of the credit account data is stored with the customer record in the CRM Module

### Embodiment 2—Customer App Communication

triggering a transmission of the credit account data to an application in operative communication with the Credit Account Management Module,
authorizing a display of the credit account data by the application when login credentials for the application have been verified,
   wherein the login credentials comprise, at least in part, a unique code generated by the Credit Account Management Module,
enabling, via the application, the credit account data to be tracked and modified,
   wherein the Merchant API module is configured to modify the credit account data in response to requests for modifications from the Credit Account Management Module, and
   wherein the Merchant API module is configured to update credit account data to the application;

### Embodiment 3—Ride Sharing API Module Communication

triggering a transmission of the credit account data to a Ride Sharing Platform via a Ride Sharing API Module,
enabling, via the Ride Sharing API Module, the credit account data to be used for services provided by the Ride Sharing Platform,
   wherein the Ride Sharing Platform is configured to transition from the credit account data to previously used transaction upon a closing of the credit account;

Tracking Credit Account Usage

tracking a usage of the credit account in the customer record;
wherein tracking the usage of the credit comprises:

### Embodiment 1—Tracking from Merchant API Module

receiving an update from the Merchant API Module,
   wherein the update comprises a transaction associated with the credit account;
displaying the update in the customer record,
   wherein the update is displayed within an activities section of the CRM Module;

### Embodiment 2—Tracking from Merchant API Module

receiving an update from the Ride Sharing API Module,
   wherein the update comprises a usage associated with the Ride Sharing Platform;
displaying the update in the customer record,
   wherein the update is displayed within an activities section of the CRM Module;

Modifying a Credit Account

enabling a modification to the credit account,
wherein the modification comprises at least one of the following:
   adding a monetary value to the credit account,
   removing a monetary value from the credit account, and
   transferring a monetary value to another credit account,
      wherein modifying the credit account comprises modifying the credit account in response to receiving a modification request from at least one of the following:
         the Credit Account Management Module, and
         the CRM Module;

Editing a Credit Account

enabling an editing of the credit account,
wherein editing the credit account comprises at least one of the following:
   modifying parameters associated with the credit account,
      wherein modifying the parameters associated with the credit account comprises, but is not limited to, at least one of the following:
         receiving a daily allocation of credit,
         receiving a duration for the credit allocation, and
         receiving a modification to any one of the aforementioned elements,
wherein editing the credit account comprises receiving a request to edit the credit account from at least one of the following:
   the CRM Module,
   the Credit Account Management Module;

Closing a Credit Account

receiving an instruction to close the credit account;

closing, in response to the command, the credit account,
wherein closing comprising paying the balance associated with the credit account on behalf of the customer,
wherein closing comprising suspending the account from further usage,
wherein closing the credit account comprises receiving a request to close the credit account from at least one of the following:
   the CRM Module,
   the Credit Account Management Module;

### V. A RIDE SHARING API MODULE

wherein the Ride Sharing API Module is in operative communication from at least one of the following:
   the CRM Module,
   the Customer Application Module,
   the Credit Account Management Module, and
   the Merchant API Module;
wherein the Ride Sharing API Module is in operative communication with at least one Ride Sharing Platform, comprising, but not limited to, at least one of the following:
   Uber,
   Lyft, and
   Gett;
wherein the Ride Sharing API Module is operative to receive instructions from at least one of the following:
   the CRM Module,
   the Customer Application Module,
   the Credit Account Management Module, and
   the Merchant API Module,
and wherein, in response to the received instructions, effect an operation of at least one of the following:
   Uber,
   Lyft, and
   Gett;

The CRM Module

receiving instructions from the CRM Module,
wherein the instructions comprise at least one of the following:
   a specification of a ride sharing platform,
   a specification of an account associated with the ride sharing platform,
      wherein the account is associated with at least one of the following:
         a customer within a customer record,
         a beneficiary within the customer record, and
         a ride sharing account ID associated with the customer and/or beneficiary;

The Customer Application Module

receiving instructions from the Customer Application Module,
wherein the instructions comprise at least one of the following:
   a specification of a ride sharing platform,
   a specification of an account associated with the ride sharing platform,
      wherein the account is associated with at least one of the following:
         a ride sharing account ID associated with the customer and/or beneficiary;

The Merchant API Module
receiving credit account data from the Merchant API Module,
verifying whether the credit account data is associated with an account specified for the ride sharing platform;
updating, upon the aforementioned verification,
wherein the credit account data is data is employed in the provisioning of each specified ride sharing platform

Operating the Ride Sharing Platform

launching the specified ride sharing platform,
wherein launching the specified ride sharing platform comprises launching the specified ride sharing platform in response to an instruction received from the Customer Application Module,
wherein launching the specified ride sharing platform comprises at least one of the following:
   logging in to the ride sharing platform with the specified account,
   provisioning the ride sharing platform with the credit account data received from the Merchant API Module,
   enabling a transaction to occur on the ride sharing platform with the credit account data,
   determining when funds associated with the credit account have reached a limited and/or a daily limit, and
   replacing, in response to the determination, a previously used credit account such that subsequent transactions on the ride sharing platform are configured to occur with the previously used credit account;

tracking a usage of the at least one ride sharing platform,
wherein tracking the usage comprises tracking each usage and transaction associated with each selected ride sharing platform; and

### Embodiment 1—CRM Module Updates

updating the CRM Module with the updated usage data of the at least one ride sharing platform,
   wherein the CRM Module is configured to update the customer record with the updated usage data;

### Embodiment 2—Credit Account Management Module Updates

updating the Credit Account Management Module with the updated usage data of the at least one ride sharing platform,
   wherein the Credit Account Management Module is configured to update the customer record with the updated usage data.

IV. Platform Architecture

The ride sharing benefit administration platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service. Although method 200 has been described to be performed by a computing device 300, it should be understood that, in some embodiments, different operations may be performed by different networked elements in operative communication with computing device 300.

Embodiments of the present disclosure may comprise a system having a memory storage and a processing unit. The processing unit coupled to the memory storage, wherein the processing unit is configured to perform the stages of method 200.

FIG. 3 is a block diagram of a system including computing device 300. Consistent with an embodiment of the disclosure, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the disclosure.

With reference to FIG. 3, a system consistent with an embodiment of the disclosure may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), nonvolatile (e.g. read-only memory (ROM)), flash memory, or any combination. System memory 304 may include operating system 305, one or more programming modules 306, and may include a program data 307. Operating system 305, for example, may be suitable for controlling computing device 300's operation. In one embodiment, programming modules 306 may include the various modules 320. Furthermore, embodiments of the disclosure may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

Computing device 300 may also contain a communication connection 316 that may allow device 300 to communicate with other computing devices 318, such as over a network in a distributed computing environment, for example, an intranet or the Internet. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g., the various modules 320) may perform processes including, for example, one or more of method 200's stages as described above. The aforementioned process is an example, and processing unit 302 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types.

Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. EXAMPLE EMBODIMENT

The following section illustrates on possible embodiment of the present disclosure by way of non-limiting example. The illustrative embodiment may be referred to as the ClaimRide® system or the ClaimRide® platform.

ClaimRide® facilitates ride share/hailing service providers for policy holders receiving transportation (rental reimbursement) benefits under their automobile insurance coverage.

The ClaimRide® solution provides ride share services that enhance and or replace a typical rental car benefit received from an insurance company, Motor Club or Roadside Assistance Company. ClaimRide® offers an end-to-end solution including a Mobile Application that facilitates ride share benefits in the event of a covered loss. Some benefits may include, but are not limited to:
Increase Revenue: ClaimRide® can be offered to customers as a standalone coverage or as an enhancement to existing rental reimbursement programs
Third Party Claim savings: Leverage ClaimRide® to effectively control third party substitute transportation expenses (rental payments)
Claim Efficiency: Reduce adjuster time processing first & third party transportation benefits
Improve Customer Experience: The ClaimRide® mobile app delivers superior transportation benefits through utilization of ride share services applying today's smart technology.

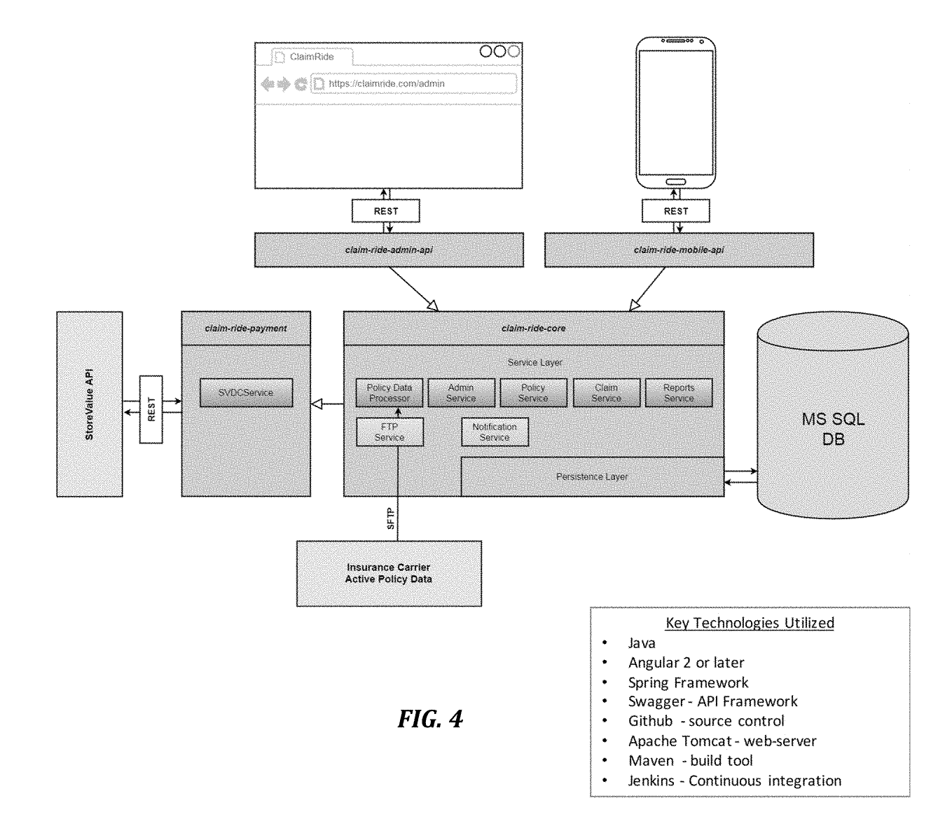

FIG. 4 illustrates one possible system architecture for the ClaimRide® system. The ClaimRide® system is a resilient cloud based platform featuring a mobile app, a web based administration portal, and digital payment solution built on a scalable and secure technology platform providing unparalleled performance, reliability, flexibility, and openness. The platform was designed and built on a completely modern architecture using a data-centric approach with the latest security mechanisms to create a best-in-class solution. Some features include, but are not limited to:
Standards—Built using Java cloud stack and Microsoft SQL, the preferred technology of the insurance industry.
Web Based—ClaimRide® benefits administration module is delivered via web and provides claim adjusters real-time access to issue, manage and control benefits.
Mobile—Policyholders and third-party beneficiaries can check benefit status, view virtual payment information and request ride share services in real-time using their iOS or Android smart phones or tablets.
Integration—Web service APIs enable ClaimRide® to integrate seamlessly into a service-oriented architecture and interact with any other applications in any technology, including simple integration with enterprise single sign on.
Secure—ClaimRide® provides mechanisms for controlling who has access to what function and what authority and benefit levels.
Digital Payments—ClaimRide® strategic partner provides compliance with MasterCard PCI and Visa services and undergoes annual reviews to maintain these regulatory certifications. The security standards also include PCI/SSAE-16 certification, disaster recovery plans, and a dedicated fraud-prevention team.
Hosted—ClaimRide® is a completely Cloud based SaaS solution eliminating the overhead and burden associated with costly servers and maintenance.
Scalable—Designed as a Software as a Service (SaaS), ClaimRide services can scale up (CPU, memory, disk) and scale out (increase number of VM instances).
Resilient—ClaimRide® software, and infrastructure is designed to be resilient and fault-tolerant.

### VI. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Although very narrow claims are presented herein, it should be recognized the scope of this disclosure is much broader than presented by the claims. It is intended that broader claims will be submitted in an application that claims the benefit of priority from this application.

The following is claimed:

1. A system comprising one or more of the following:
a CRM module;
an Customer Application module;
a Merchant API module;
a Credit Account Management module;
a Ride Sharing API module; and
wherein at least one or more modules is operable with at least one other module.

2. The system of claim 1, further comprising the CRM module wherein the CRM module is configured for:
retrieving a customer record in a database;
wherein the customer record is stored within a CRM software,
wherein the CRM software is configured to manage insurance claims,
wherein the CRM software comprises, for each customer records, but is not limited to, at least one of the following:
carrier information,
policy information,
beneficiary information,
current benefit,
benefit balance,
benefit duration, and
credit account activity,
wherein the CRM software is configured to authorize a credit account for the customer record by,
associating the customer record with a incident;
wherein the incident comprises a claim for compensating a customer associated with the customer record;
specifying a monetary value associated with the incident;
wherein the monetary value corresponds to a calculation of a compensation amount for the claim;
wherein the monetary value is associated with a daily budget provided to the customer associated with the customer record; and
wherein the daily budget is specified to be allocated for a number of days.

3. The system of claim 2, the CRM module further comprising:
requesting an issuance of a credit account associated with the customer record,
wherein the issuance request is performed via the Merchant API Module,
wherein requesting the issuance of the credit account comprises submitting at least one of the following:
a beneficiary name, and
contact information associated with the beneficiary name;
confirming the issuance of the credit account associated with the customer record,
wherein the confirmation of the issuance is performed the Merchant API Module;
causing a communication of credit account data to the customer,
wherein causing the communication of the credit account data to the customer comprises at least one of the following:
providing customer record data to the Merchant API Module; and
wherein the customer record data comprising customer contact information, the customer contact information being used to communicate account data, via the Merchant API Module, to the customer.

4. The system of claim 3, the CRM module further comprising:
displaying a credit account associated with the customer record,
wherein displaying the credit account associated with the customer record further comprises tracking a usage of the credit account via the Credit Account Management Module,
wherein updated values associated with the credit account are retrieved from the Merchant API Module; and
tracking a usage of the credit account associated with customer record,
wherein tracking the usage of the credit account data comprises communicating data with at least one of, or a combination of, the following:
the Merchant API Module,
the Ride Sharing API Module, and
the Credit Account Management Module.

5. The system of claim 4, the CRM module further comprising:
enabling modifications the credit account associated with the customer record,
wherein the modifications comprise at least one of the following:
adding a monetary value to the credit account,
removing a monetary value from the credit account, and
transferring a monetary value to another credit account,
wherein the modifications are enabled via the Merchant API Module;
closing the credit account,
wherein closing comprising paying the benefit balance associated with the credit account on behalf of the customer,
wherein closing comprising suspending the credit account from further usage, and
wherein closing the credit account is enabled via the Merchant API Module.

6. The system of claim 1, further comprising wherein the Customer Application module is operable with at least one of:
the CRM Module;
the Merchant API Module; and
the Ride Sharing API Module.

7. The system of claim 2, further comprising wherein the Customer Application module is configured to:
providing an application to the customer associated with the customer record,
wherein providing the application comprises enabling the customer to download an application,
wherein enabling the customer to download the application comprises communicating a link to the customer,
wherein communicating the link with the customer comprises communicating the link via at least one of the following:
SMS, MMS, and EMAIL,
wherein communicating a link comprises communicating a unique ID in addition to the link,
wherein the unique ID is configured to associate the application with the customer record in the CRM Module;
wherein the application is at least one of the following;
an application configured to operate on a mobile computing device, and
a web-based application;
wherein the application is an extension to the CRM Module,
wherein the application is operable via communication with the CRM Module,
wherein the CRM Module is configured to remotely operate at least one feature and at least one function of the application.

8. The system of claim 7, further comprising wherein the Customer Application module is configured for:
wherein the application is configured to communicate with the Merchant API Module,
wherein the Merchant API Module is configured to communicate credit account data to the application,
wherein at least a portion of the credit account data is not accessible to the CRM Module,
wherein the application is configured to display credit account data to the customer,
wherein the credit account data is received from at least one of, or a combination of, the following:
the Merchant API Module, and
the CRM Module;
wherein the credit account data comprises at least one of the following:
a credit account number,
a credit account expiration date,
a credit account provider, and
an image associated with at least one of: the credit account number, the credit account expiration date, and the credit account provider.

9. The system of claim 8, further comprising wherein the Customer Application module is configured for:
wherein the application is configured to display a credit account status to the customer,
wherein the credit account data is received from at least one of, or a combination of, the following:
the Merchant API Module, and
the CRM Module;
wherein the credit account status comprises at least one of the following:
an insurance carrier associated with the credit account,
a claim number associated with the credit account,
an authorized benefit corresponding to a monetary value,
a benefit balance corresponding to a balance of the credit account;
wherein the application is configured to enable an operation of a Ride Sharing API Module,
wherein the operation of the Ride Sharing API Module comprises loading a Ride Sharing Application,
the Ride Sharing Application comprising, but not limited to, any one of the following:
Uber,
Lyft, and
Gett.

10. The system of claim 9, further comprising wherein the Customer Application module is configured for:
wherein the operation of the Ride Sharing API Module comprises communicating credit account data to the Ride Sharing API Module,
wherein communicating the credit account data comprises causing the Merchant API Module to communicate credit account data to a Ride Sharing API Module,
wherein communicating the credit account data comprises:
replacing an existing credit account associated with the customer's record with a credit account issued by the Merchant API Module,
wherein replacing the existing credit account with the issued credit account comprises:
enabling the Ride Sharing API Module to charge the issued credit account for usage, and
replacing the issued credit account with the existing credit account once a monetary value associated with the issued credit account has been depleted.

11. The system of claim 1, further comprising wherein the Merchant API module is configured for:
issuing a credit corresponding to a specified monetary value;
wherein issuing the credit corresponding to the specified monetary value comprises issuing a credit in response to a request from a CRM Module;
wherein operating the Merchant API Module comprises operating the Merchant API Module in accordance to instructions received from at least one of the following:
the CRM Module, and
the Credit Account Management Module,
accessing a financial institution system via a Merchant API;
requesting, via the Merchant API, an issuance of a credit account for a customer,
wherein requesting the issuance of the credit comprises providing at least one of the following along with the request:
a customer name, and
customer contact information;
establishing the credit account;
the credit account comprising a credit value corresponding to the specified monetary value;
providing a confirmation of the credit account issuance,
wherein providing the confirmation of the credit account issuance comprises providing the confirmation to at least one of the following:
the CRM Module, and
the Credit Account Management Module.

12. The system of claim 11, further comprising wherein the Merchant API module is configured for:
sharing credit account data,
wherein the credit account data comprises at least one of the following:
a credit account number,
a credit account expiration date,
a credit account provider, and
an image associated with at least one of: the credit account number, the credit account expiration date, and the credit account provider.

13. The system of claim 12, further comprising wherein the Merchant API module is configured for:
transmitting the credit account data to a Credit Account Management Module,
enabling, via the Credit Account Management Module, the credit account data to be tracked and modified,
wherein the Merchant API is configured to modify the credit account data in response to requests for modifications from the Credit Account Management Module, and
wherein the Merchant API is configured to update credit account data to the Credit Account Management Module.

14. The system of claim 13, further comprising wherein the Merchant API module is configured for:
enabling a modification to the credit account,
wherein the modification comprises at least one of the following:
adding a monetary value to the credit account,
removing a monetary value from the credit account, and
transferring a monetary value to another credit account,
wherein modifying the credit account comprises modifying the credit account in response to receiving a modification request from at least one of the following:
the Credit Account Management Module, and
the CRM Module.

15. The system of claim 13, further comprising wherein the Merchant API module is configured for:
enabling an editing of the credit account,
wherein editing the credit account comprises at least one of the following:
modifying parameters associated with the credit account,
wherein modifying the parameters associated with the credit account comprises, but is not limited to, at least one of the following:
receiving a daily allocation of credit,
receiving a duration for the credit allocation, and
receiving a modification at least one of: the daily allocation of credit and the credit allocation; and
wherein editing the credit account comprises receiving a request to edit the credit account from at least one of the following:
the CRM Module,
the Credit Account Management Module.

16. The system of claim 13, further comprising wherein the Merchant API module is configured for:
closing the credit account,
wherein closing comprising paying a balance associated with the credit account on behalf of the customer,
wherein closing comprising suspending the credit account from further usage,
wherein closing the credit account comprises receiving a request to close the credit account from at least one of the following:
the CRM Module,
the Credit Account Management Module.

17. The system of claim 1, further comprising the Credit Account Management module wherein the one or module is configured for:
requesting an issuance of a credit account associated with a customer record,
wherein the customer record is retrieved from the CRM Module,
wherein the issuance request is performed via the Merchant API Module,
wherein requesting the issuance of the credit account comprises providing, to the Merchant API Module, at least one of the following:
a beneficiary name, and
contact information associated with the beneficiary name;
confirming the issuance of the credit account associated with the customer record,
wherein the confirmation of the issuance is performed the Merchant API Module;
controlling distribution and usage of credit account data;
wherein controlling the distribution and usage of the credit account data associated with a customer comprises at least one of the following:
enabling a transmission of the credit account data directly to a customer associated with the customer record, wherein transmitting the credit account data comprises:
retrieving contact information for the customer from the customer record,
wherein retrieving the contact information employs the CRM Module, and
sharing the credit account data with the customer,
wherein sharing the credit account data employs the Merchant API module,
wherein a portion of the credit account data shared with the customer is not available to the CRM Module,
wherein the portion of the credit account data not available to the CRM module comprises, but is not limited to, a credit card number;
enabling a transmission of a limited portion of the credit account data to the CRM module,
wherein the limited portion of the credit account data excludes the credit card number,
wherein the limited portion of the credit account data is stored with the customer record in the CRM Module
triggering a transmission of the credit account data to an application in operative communication with the Credit Account Management Module,
authorizing a display of the credit account data by the application when login credentials for the application have been verified,
wherein the login credentials comprise, at least in part, a unique code generated by the Credit Account Management Module,
enabling, via the application, the credit account data to be tracked and modified,
wherein the Merchant API module is configured to modify the credit account data in response to requests for modifications from the Credit Account Management Module, and
wherein the Merchant API module is configured to update credit account data to the application; and
triggering a transmission of the credit account data to a Ride Sharing Platform via a Ride Sharing API Module,
enabling, via the Ride Sharing API Module, the credit account data to be used for services provided by the Ride Sharing Platform,
wherein the Ride Sharing Platform is configured to transition from the credit account data to previously used transaction upon a closing of the credit account.

18. The system of claim 1, further comprising the Ride Sharing API module further configured for:
receiving instructions from the CRM Module,
wherein the instructions comprise at least one of the following:
a specification of a ride sharing platform,
a specification of an account associated with the ride sharing platform,
wherein the account is associated with at least one of the following:
a customer within a customer record,
a beneficiary within the customer record, and
a ride sharing account ID associated with the customer;
receiving instructions from the Customer Application Module,
wherein the instructions comprise at least one of the following:
a specification of a ride sharing platform,
a specification of an account associated with the ride sharing platform,
wherein the account is associated with at least one of the following:
a ride sharing account ID associated with the customer;
receiving credit account data from the Merchant API Module,
verifying whether the credit account data is associated with an account specified for the ride sharing platform; and
updating, upon the verification, wherein the credit account data is data is employed in provisioning of each specified ride sharing platform.

19. A non-transitory computer-readable medium comprising a set of instructions which when executed are configured to enable a method comprising:
establishing a customer record in a database;
associating the customer record with an incident;
determining a monetary value associated with the incident;
issuing a credit corresponding to the determined monetary value;
wherein issuing the credit based upon the monetary value comprises:
accessing an API,
requesting, via the API, an issuance of a credit account corresponding to the credit,
wherein requesting the issuance of a credit account comprises submitting a customer name and customer contact information;
establishing the credit account;
issuing, via the API, a confirmation of a credit issuance, and
enabling, via the API, modifications to the credit account, wherein the modifications comprise at least one of the following:
adding to a credit amount to the credit account,
removing a credit amount from the credit account, and
transferring a credit amount to another credit account;
sharing credit account data, wherein sharing the credit account data comprises at least one of the following:
transmitting a first set of data points associated with the credit account directly to a customer associated with the customer record, wherein transmitting the first set of data points comprises:
retrieving, via an API, contact information for the customer from the customer record,
enabling the customer to obtain an application for receiving and displaying the first set of data points, and
sharing the first set of data points with the customer, wherein the first set of data points are not available to the customer record database;
transmitting a second set of data points associated with the credit account to the customer record database,
wherein a portion of the second set of data points correspond to the first set of data points; and
transmitting credit account data to a Ride Sharing Platform via a Ride Sharing API, wherein transmitting the credit account data to the Ride Sharing Platform further comprises:
enabling, via the Ride Sharing API, the credit account data to be used for services provided by the Ride Sharing platform,
wherein the Ride Sharing Platform is configured to transition from the credit account data to previously used transaction upon a closing of the credit account;
tracking a usage of the credit account in the customer record;
wherein tracking the usage of the credit comprises:
receiving an update from a Merchant API, and
displaying the update in the customer record of a CRM module;
receiving an update from the Ride Sharing API, and
displaying the update in the customer record of the CRM module; and
closing the credit account,
wherein closing the credit account comprises at least one of the following:
paying an account balance associated with the credit account on behalf of the customer,
suspending the credit account from further usage, and
disabling the credit account.

20. A method, comprising:
specifying a customer and a monetary value associated with an incident within a CRM module;
requesting issuance of credit via a merchant API module;
establishing a credit account for the customer with the specified monetary value;
sharing credit account data with the customer via a customer application module;
enabling an application of the credit account to a ride sharing platform via a ride sharing API module;
tracking usage of the credit account via a credit account management module; and
closing the credit account upon meeting account deactivation criteria.
